(19) United States
(12) Patent Application Publication
(10) Pub. No.: US 2024/0418972 A1
(43) Pub. Date: Dec. 19, 2024

(54) PHOTOSTABLE CRYSTALLINE SUBSTRATES FOR FLUORESCENCE MICROSCOPY

(71) Applicant: ARACELI BIOSCIENCES INC., Tigard, OR (US)

(72) Inventor: Theresa L. Thompson, West Linn, OR (US)

(21) Appl. No.: 18/335,770

(22) Filed: Jun. 15, 2023

(51) Int. Cl. G02B 21/00

(52) U.S. Cl. CPC G02B 21/0076

(57) ABSTRACT

Systems and methods are provided herein for balancing a microscopy system. A photostable fluorescence balancing target may include an inorganic crystalline fluorophore affixed to a holder. A fiducial marker is positioned on the inorganic crystalline fluorophore.

### FIELD

Embodiments of the subject matter disclosed herein relate generally to fluorescence microscopy, and more particularly to photostable crystalline substrates for balancing microscopes over time.

### BACKGROUND/SUMMARY

Fluorescence microscopy is used in the biological sciences for observation of fluorescent and/or fluorescently-labeled cellular structures, proteins, and nucleic acids, among other biomolecules. A fluorescence microscopy based assay may demand acquiring multiple fluorescent images on a single microscope (e.g., microscope system) over time, and/or a plurality of microscope systems. For this reason, the single microscope system and/or plurality of microscope systems may be matched (e.g., balanced) over time for uniform image quality. Three considerations for balancing microscope systems are brightness, contrast, and photobleaching. In some examples, matching images may include adjusting a power output of a light source of the microscope at a relevant excitation wavelength. In alternate examples, matching may include adjusting a focus and excitation light intensity at the sample plane for each wavelength channel of the single microscope. Further, it may be desirable to also balance between multiple wavelength channels on the single microscope.

Photobleaching may be a significant limiting factor for balancing microscope systems. Photobleaching refers to a decrease in fluorescent yield of a fluorophore over time due to degradation caused by light exposure. Standard organic fluorescent dyes used for cell imaging may be particularly prone to photobleaching, making them ill-suited as a fluorophore for balancing the microscopy system. Current approaches for microscope system balancing include matching a power output of an emission source without a fluorescent target or use of fluorescent acrylic slides of various colors, each designed for response to specific wavelengths. However, the acrylic may also be prone to photobleaching over time and it is recommended to change fields of view as used areas fade. Changing field of view may introduce unwanted variance due differences in age, light exposure, and slide thickness, among others, which may result in a larger variation in fluorescent images acquired by the microscope system. Additionally, different acrylic slides may be needed to balance between multiple wavelength channels of the microscope system. Further, balancing without the fluorescent target may not account for a complete optical path of the microscope system.

The inventors herein have recognized the above-mentioned issues and have engineered a way to at least partially address them. In one example, a photostable fluorescence balancing target may include a holder, an inorganic crystalline fluorophore affixed to the holder, and a fiducial marker positioned on the inorganic crystalline fluorophore. In this way, by using an inorganic crystalline fluorophore material as a reference material, a photostable (e.g., non-photobleaching) fluorophore capable of being excited across a range of visible wavelengths of light may be provided. Using the inorganic crystalline material, a microscope system and/or a plurality of microscope systems may be balanced without interference from photobleaching. Balancing among the plurality of microscope systems allows for large assays demanding multiple sample plates over one or more wavelength channels and one or more microscope systems to be performed while still resulting in uniform data. Additionally, users may efficiently adjust microscope system parameters between dyes that demand different excitation parameters. Further, aging of an excitation light source over time may be compensated for by periodic rebalancing of the microscope system.

The above advantages and other advantages, and features of the present description will be readily apparent from the following detailed description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a microscope system.

FIG. 2 shows a perspective view of a multi-detector microscopy system.

FIG. 3A shows example images of emerald crystals imaged with multiple wavelength channels.

FIG. 3B shows example images of ruby crystals imaged with multiple wavelength channels.

FIG. 4 shows example images of ruby crystals before and after light exposure.

FIG. 5A shows an example of a photostable fluorescence balancing target.

FIG. 5B shows a magnified view of the photostable fluorescence balancing target of FIG. 5A.

FIG. 6 shows a flowchart of an example method for fluorescence balancing using the photostable fluorescence balancing target.

FIG. 7 shows an example of an image of the crystalline fluorescence balancing target collected with a microscope system.

FIG. 8 shows a plot of excitation power and contrast sampled during fluoresce balancing.

### DETAILED DESCRIPTION

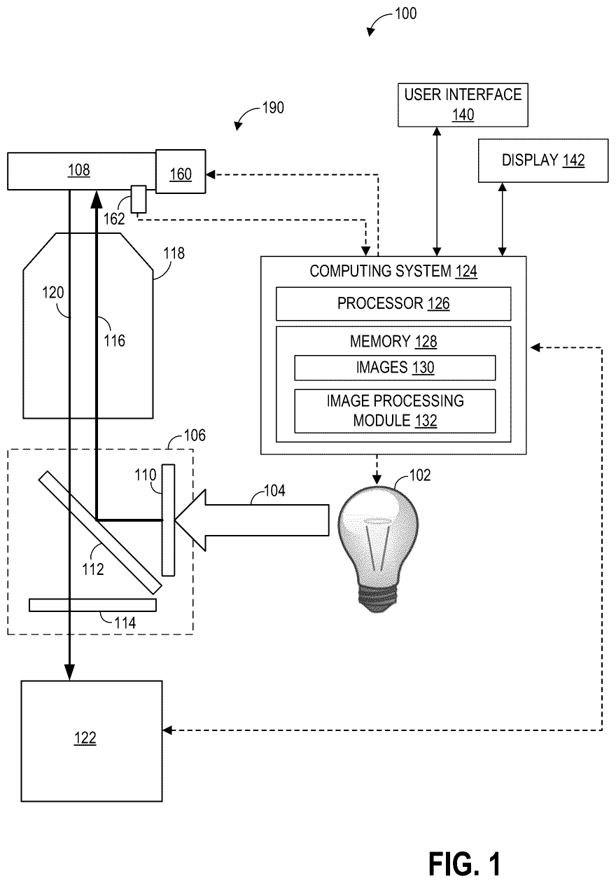

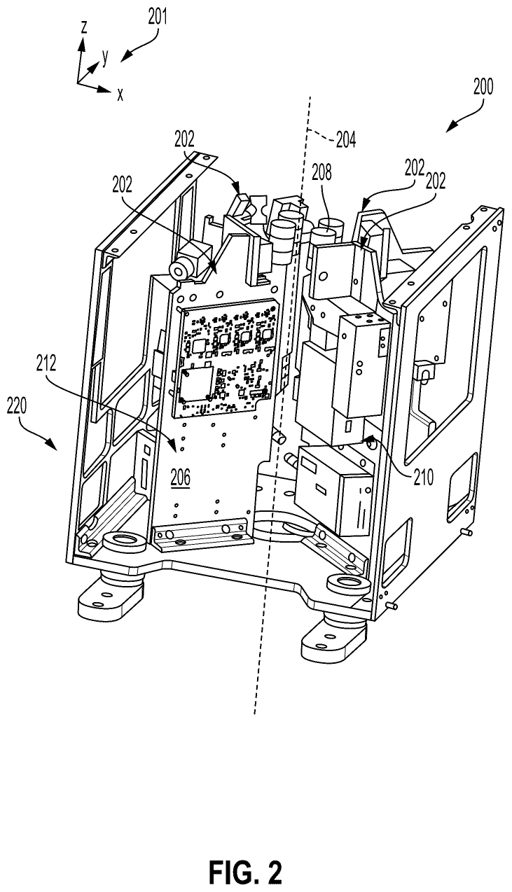

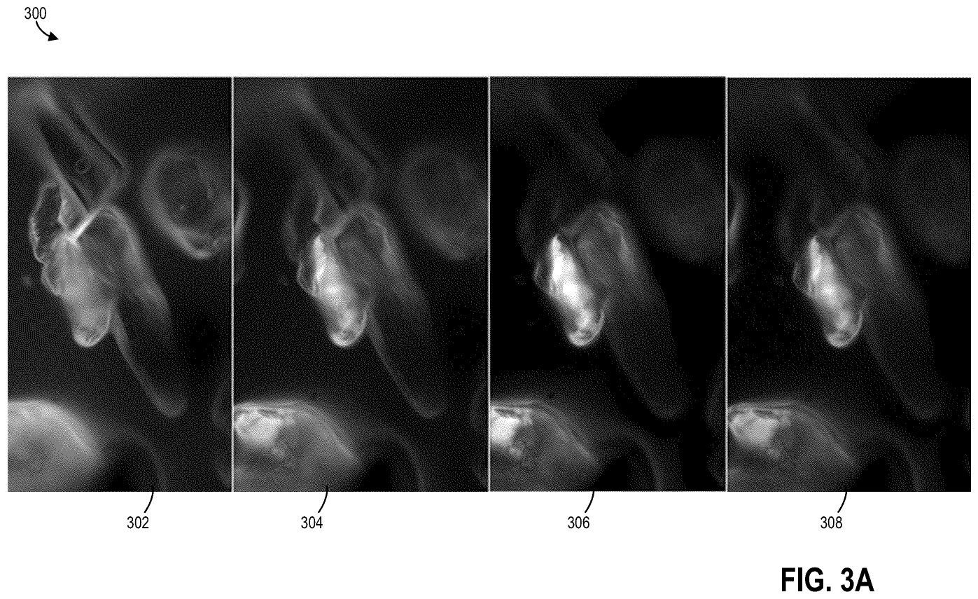

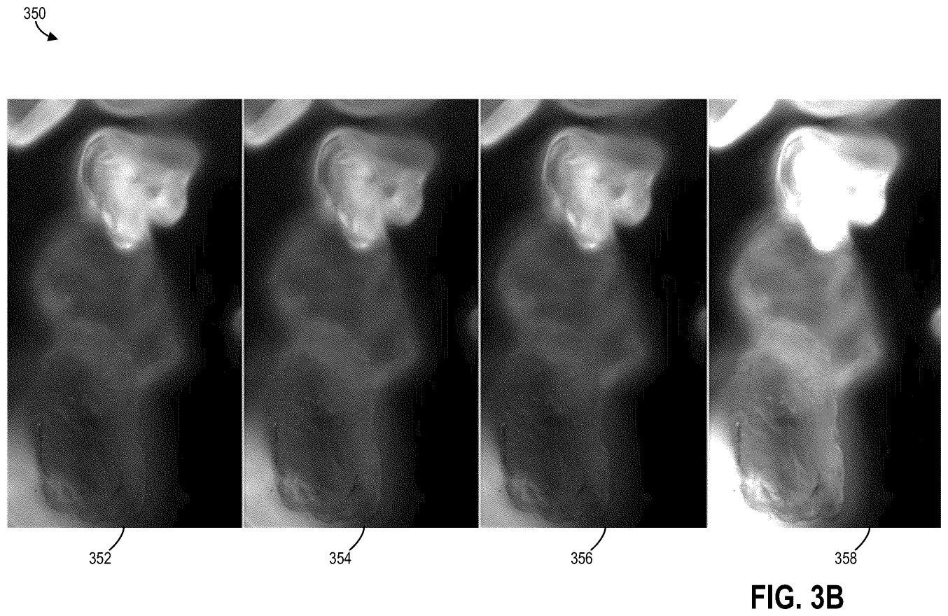

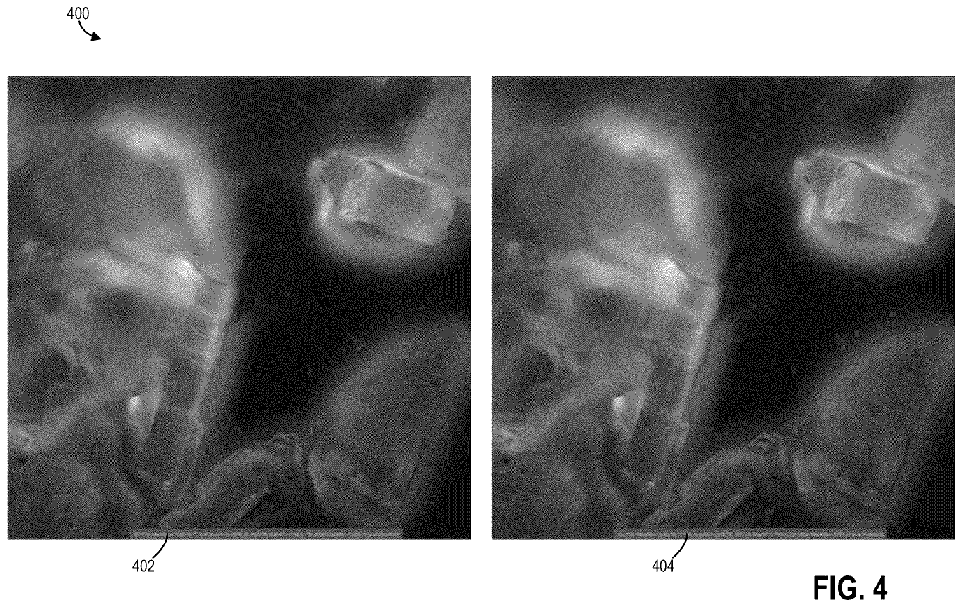

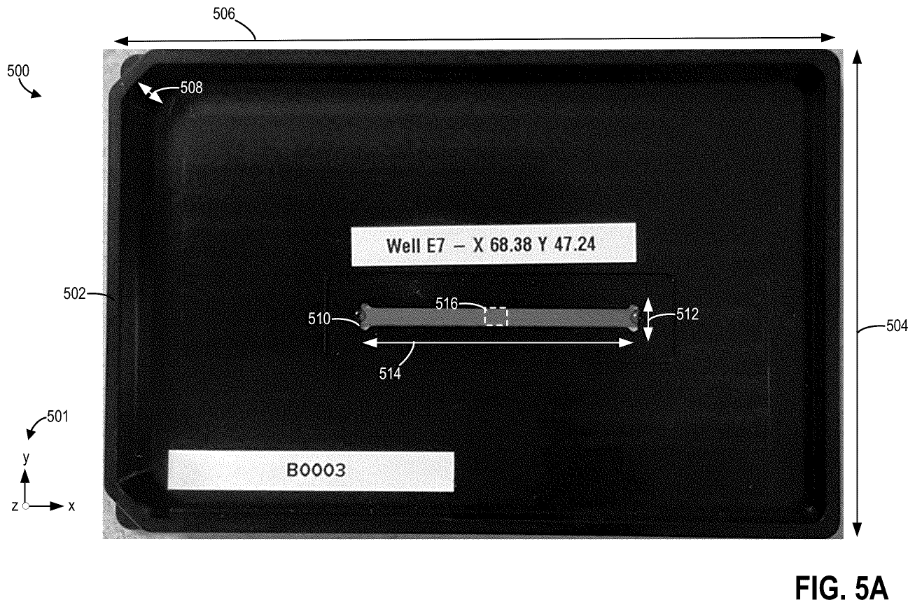

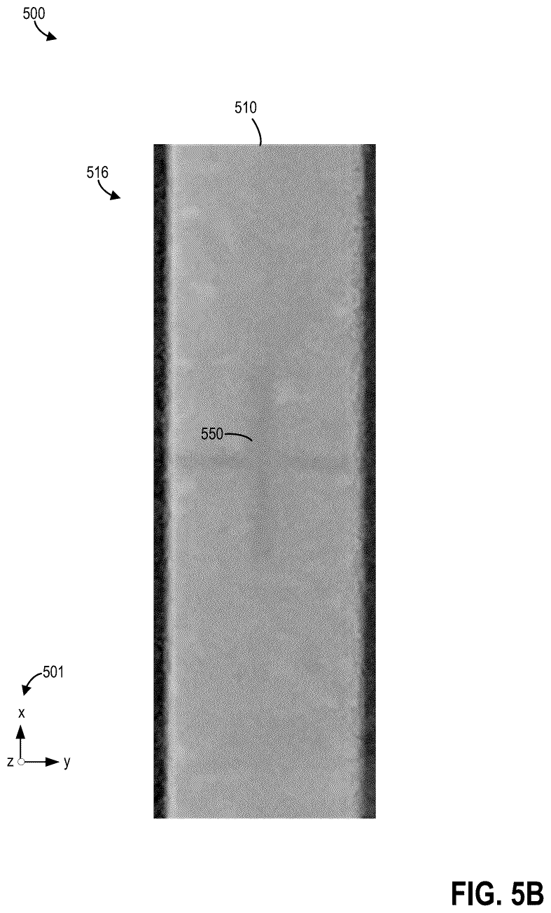

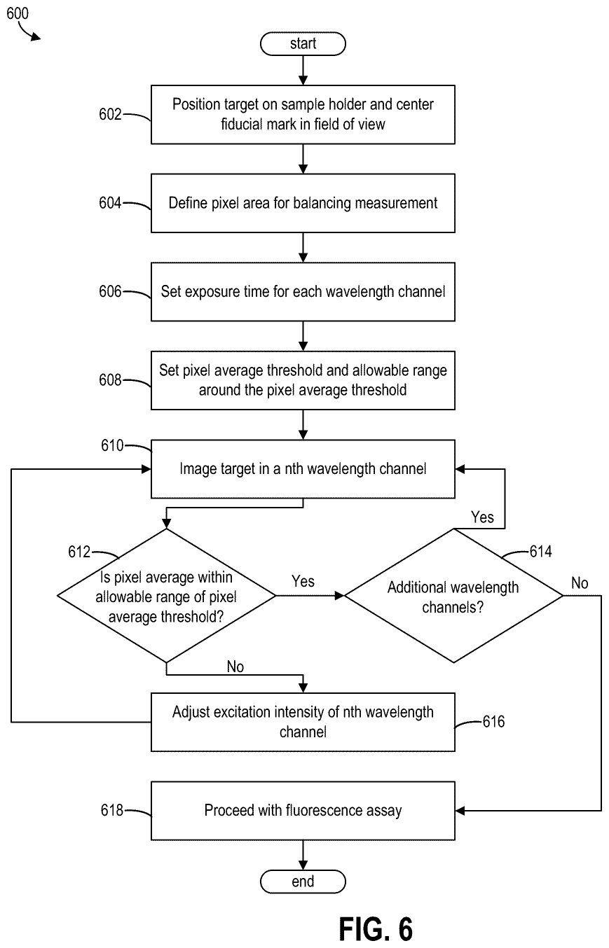

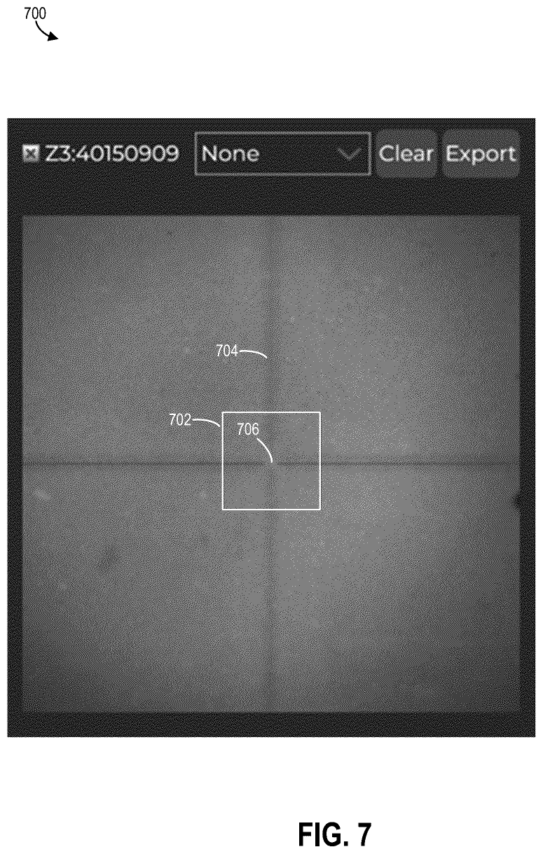

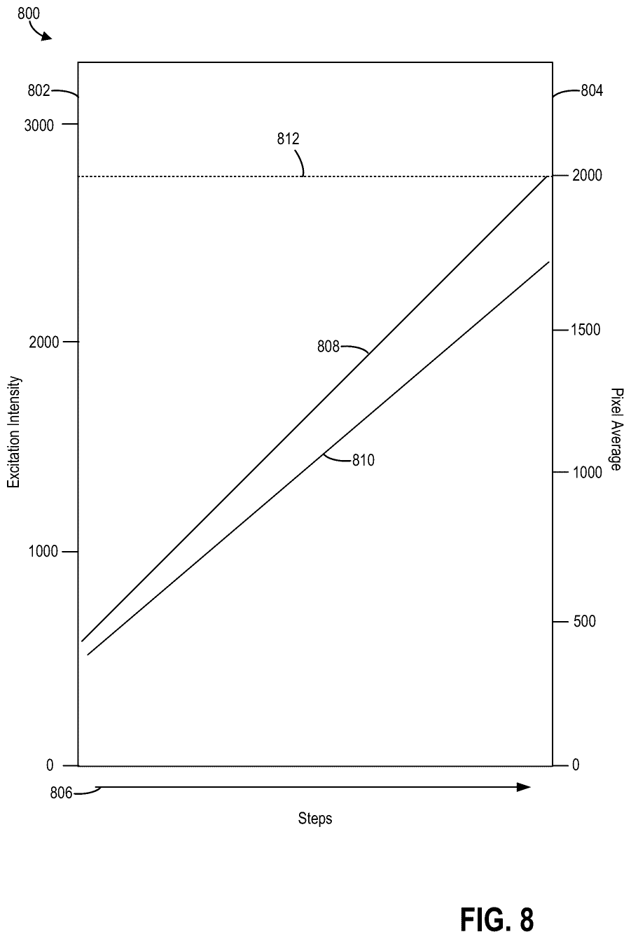

The present description is related to systems and methods for balancing fluorescence microscope systems (e.g., microscope systems). Herein, balancing refers to adjusting operational settings of a fluorescence microscope, such as emission source intensity, in order to achieve reproducible fluorescence assays on a single microscope system over time and/or between a plurality of microscope systems. In some examples, the microscope system may be a fluorescence microscope system, such as microscope system 100 shown in FIG. 1. An example of a microscope system, such as the one shown schematically in FIG. 1 is a quantitative multi-detector microscopy system 200 illustrated in FIG. 2. A desirable material for balancing a microscope system such as microscope system 100 and/or multi-detector system 200 may be chemically stable as well as photostable (e.g., not prone photobleaching). Photobleaching refers to a decrease in fluorescence yield caused by light induced degradation of the fluorophore. Additionally, the material may absorb and emit visible light across a wide spectrum. In this way, a single material may be used for all wavelength channels of a single microscope system. Certain inorganic crystalline materials are both photostable and absorb and emit visible light. Examples of possible inorganic crystalline materials which may be used for balancing the microscope system imaged across multiple wavelength channels of an instrument are shown in FIGS. 3A-3B while FIG. 4 shows images of the inorganic crystalline material before and after conditions that may typically cause photobleaching of organic fluorophores. The inorganic crystalline material may be incorporated into a photostable fluorescence balancing target as shown in FIGS. 5A and 5B. An example of a method for using the photostable fluorescence balancing target to automatically balance an instrument such as microscope system 100 is shown in FIG. 6. FIGS. 7-8 show examples of an image and microscope system parameters which may be generated as a result of balancing the microscope system following the method described in FIG. 8.

Turning now to FIG. 1, a schematic diagram for a microscope system 100 (hereafter, the system 100) is shown. In one example, the system 100 may be configured as a fluorescence microscope system. An imager 190 of the system 100 may include a light source 102 providing incident light to components arranged in a path of the incident light, as indicated by arrow 104. The light source 102 may be a mercury-vapor lamp, a xenon arc lamp, halogen lamp, a laser, or one or more light-emitting diodes (LEDs). An intensity of light emitted by the light source 102 may be adjusted by the system 100. As one example, the intensity may be adjusted by increasing or decreasing a current use to power the light source 102. In some examples, the system 100 may be included in a multi-detector microscope system.

The incident light may be directed to a filter cube 106 (e.g., also called a filter block). The filter cube 106 may house components that filter the incident light such that target wavelengths are transmitted to a target to be analyzed, e.g., one or more samples supported on a sample holder 108. In one example, the sample holder 108 may be a microplate. In the example of FIG. 1, three filtering components are arranged in the filter cube 106, including an excitation filter 110, a dichroic filter 112, and an emission filter 114. The incident light may first pass through the excitation filter 110 which filters the light to allow select, e.g., target, wavelengths to continue past the excitation filter 110 and block other wavelengths of light. The target wavelengths may be wavelengths that excite electrons in specific fluorophores or fluorochromes, resulting in release of photons when the excited electrons relax to a ground state.

The excitation light, e.g., light that has been filtered by the excitation filter 110, then strikes the dichroic filter 112 (or dichroic beamsplitter), as indicated by arrow 116. The dichroic filter 112 may be a mirror, for example, arranged at a 45 degree angle relative to an optical path of the system 100, e.g., angled at 45 degrees relative to the path of incident light indicated by arrow 104. A surface of the dichroic filter 112 may include a coating that reflects the excitation light, e.g., light filtered by the excitation filter 110, but allows fluorescence emitted from the sample at the sample holder 108 to pass therethrough. The reflected excitation light, as indicated by arrow 116, passes through an objective lens 118 to illuminate the sample holder 108. If the sample positioned in the sample holder 108 fluoresces, light is emitted, e.g., generating emission light as indicated by arrow 120, and collected by the objective lens 118. The emission light passes through the dichroic filter 112 and continues to the emission filter 114, which blocks undesired excitation wavelengths from passing therethrough. The filtered emission light is received at a detector 122.

The light source 102, the excitation filter 110, and the dichroic filter 112 may be selected according to known absorption and emission spectra of a fluorophore of interest. A combination of light source 102, excitation filter 110 and dichroic filter 112 may be referred to as a wavelength channel. For example, a first wavelength channel may be a blue channel, a second wavelength channel may be a green channel, and a third wavelength channel may be red channel, and fourth wavelength channel may be a far red channel. The color may refer to a region of the visible spectrum corresponding to emission and excitation wavelengths. The detector 122 may be a camera, such as a charge-coupled device (CCD) camera, in one example. In other examples, the detector 122 may be another type of camera, for example, a CMOS camera, or a photomultiplier tube.

At the detector 122, the emission light may be converted into electronic data. For example, when the detector 122 is the CMOS camera, the detector 122 may include a light sensor configured as a transistor on an integrated circuit. Photons of the emission light may be incident on the light sensor and generate an electrical charge that is converted into electronic data representative of a photon pattern of the emission light captured within a field of view (FOV) of the camera. The electronic data may be stored as a memory of the camera, such as random access memory, and may be retrieved by a computing system 124.

The computing system 124 may be a computing device or other computer. The computing system 124 may include a processor 126 and a memory 128. The processor 126 may comprise one or more computational components usable for executing machine-readable instructions. For example, the processor 126 may comprise a central processing unit (CPU) or may include, for example a graphics processing unit (GPU). The processor 126 may be positioned within the computing system 124 or may be communicatively coupled to the computing system 124 via a suitable remote connection.

The memory 128 may comprise one or more types of computer-readable media, including volatile and/or non-volatile memory. The volatile memory may comprise, for example, random-access memory (RAM), and the non-volatile memory may comprise read-only memory (ROM). The memory 128 may include one or more hard disk drive(s) (HDDs), solid state drives (SSDs), flash memory, and the like. The memory 128 is usable to store machine-readable instructions, which may be executed by the processor 126. The memory 128 is further configured to store images 130, which may comprise digital images captured or created using a variety of techniques, including digital imaging, digital illustration, and more. The images 130 may further include one or more reference images and/or one or more acquired images.

At least a portion of the images 130 may be acquired via the system 100. The memory 128 further includes an image processing module 132, which comprises machine-readable instructions that may be executed by the processor 126. The image processing module 132 may include machine-readable instructions for manipulation of digital images (e.g., the images 130). For example, the machine-readable instructions stored in the image processing module 132 may correspond to one or more methods, examples of which are provided with respect to FIG. 6.

The system 100 further includes a user interface 140, which may comprise one or more peripherals and/or input devices, including, but not limited to, a keyboard, a mouse, a touchpad, or virtually any other input device technology that is communicatively coupled to the computing system 124. The user interface 140 may enable a user interact with the computing system 124, such as to select one or more images to evaluate, to select one or more parameters of the imager 190, and so forth.

The system 100 further includes a display device 142, which may be configured to display the images themselves, and display possible parameter options and selections related to the acquisition of images, including one or more dye wavelengths, channels, and emission spectra, for example. The user may select or otherwise input parameters via the user interface 140 based on options displayed via the display device 142.

The computing system 124 may be communicatively coupled to components of the system 100. For example, the computing system 124 may be configured to command activation/deactivation of the light source 102 when prompted based on and/or in response to user input. As another example, the computing system 124 may instruct adjustment of a position of the sample holder 108 to focus the excitation light on a different region of the sample holder. The computing system 124 may command actuation of a motor 160 coupled to the sample holder 108 to vary the position of the sample holder 108 with respect to the objective lens 118 and the excitation light and provide instructions on how the sample holder position is to be modified. In some examples, a position sensor 162 may monitor the actual position of the sample holder 108 and may be communicatively coupled to the computing system 124 to relay the sample holder position to the computing system 124.

The computing system 124 may also be communicatively coupled to the detector 122. As such, electronic data collected by the detector 122 may be retrieved by the computing system 124 for further processing and display at an interface, such as a computer monitor. It will be appreciated that the computing system 124 may be further coupled to other sensors and actuators of the system 100. In one example, communication between the computing system 124 and the sensors and actuators of the system 100 may be enabled by various electronic cables, e.g., hardwiring. In other examples, the computing system 124 may communicate with the sensors and actuators via a wireless protocol, such as Wi-Fi, Bluetooth, Long Term Evolution (LTE), etc.

It will be appreciated that the system 100 depicted in FIG. 1 is a non-limiting example of a fluorescence microscope system. Other examples may include variations in quantities of individual components, such as a number of dichroic, excitation, and emission filters, a configuration of the light source, relative positioning of the components, etc. In one example, the fluorescence microscope system, e.g., the system 100 of FIG. 1, may be used for high through-put screening of biological samples.

As one example, the system 100 may be a quantitative multi-detector fluorescence microscopy system (e.g., multi-detector system 200). As shown in FIG. 2, the multi-detector system 200 may be formed of four individual blades 202 arranged in an x-shaped configuration. The multi-detector system 200 is depicted in FIG. 2 with an upper portion of the system and portions of a housing 220 of the multi-detector system 200 omitted for clarity. The upper portion may include a top plate of the housing 220 of the multi-detector system 200 as well as a sample receiving assembly. A set of reference axes 201 is provided, indicating a y-axis, an x-axis, and a z-axis. In one example, the z-axis may be parallel with a direction of gravity. Furthermore, a central axis 204 of the multi-detector system 200 may be parallel with the z-axis. Each blade 202 of the multi-detector system 200 may include at least the components depicted in the system 100 of FIG. 1 and the blades 202 may be operated concurrently to collect image data in parallel. Each blade 202 therefore forms an individual quantitative microscopy assembly. In some examples, each blade 202 may include four wavelength channels as described above. In some examples, each separate blade may include the same wavelength channel (e.g., the same excitation and emission wavelengths). The components arranged in each of the blades 202 may be positioned to optimize both an FOV of an objective of each blade and a magnification/resolution of the resulting images. As such, the components may be arranged in a vertical orientation, e.g., as a stack along each blade.

For example, each blade 202 of the multi-detector system 200 may be similarly configured, including a vertically oriented plate 206 supporting a variety of components. An objective lens 208, which may be an embodiment of the objective lens 118 of FIG. 1, may be positioned at a top of each blade 202 with other components of each blade 202 arranged below the objective lens 208, with respect to the z-axis. The blade 202 may have a front side 210 and a back side 212.

The multi-detector system 200 may offer several advantages over conventional systems. For example, conventional systems may employ multiple detectors to enable parallel imaging of microplates, thereby increasing throughput. However, the conventional systems may not enable a higher imaging frequency of a single microplate. As a result of a packaging of the multi-detector system 200, and in particular, an arrangement of the objective lens 208 at an upper portion of the multi-detector system 200 below the microplate, the quantitative microscopy assemblies of the multi-detector system 200 may synchronously capture images of portions of the microplate. The images may be combined to form a complete image of the microplate, thus expediting a speed at which each well of the microplate is indexed. The packaging of the multi-detector system 200 allows the multi-detector system 200 to have a similar footprint to a system with a single quantitative microscopy assembly.

Furthermore, in one example, the high speed imaging provided by the multi-detector system 200 may allow the multi-detector system 200 to be used for imaging live biological specimens in addition to endpoint assays. In addition to the imaging speed, a fast frame rate and high cycling frequency of the multi-detector system 200 may enable new observations of biology, such as live events and transient cell signals, which may otherwise be challenging to obtain using the conventional systems. As a result, cellular models may be constructed with greater accuracy.

In addition, the arrangement of the objectives enables both high speed imaging of the microplate and efficient packaging of other components of the quantitative microscopy assemblies, such as a detector and a light source, to minimize the footprint of the multi-detector system 200. The objectives may be positioned relative to one another with a target distancing or spacing therebetween that accommodates a specific geometry of the microplate and reduces instances where a focus of any of the objectives migrates outside of a target imaging region of the microplate. A resulting capability of the objectives to rapidly capture images of the microplate in a synchronized manner may not be readily replicated with other arrangements of the objectives.

In some examples, the multi-detector system 200 may be further configured with environmental control capabilities. For example, the microplate may be enclosed within a sealed structure such that exposure of the sample to temperature, humidity, carbon dioxide level, etc., may be regulated. Furthermore, the multi-detector system 200 may be adapted with a rapid, automated microplate changing mechanism, such as an automated robotic arm.

In some examples, including when a fluorescence microscope system (e.g., the system 100 of FIG. 1 and/or multi-detector system 200) is used for high through-put screening, multiple samples (e.g., microplates) may be measured on a single microscope system, multiple plates of a multi-detector system and/or a plurality of microscope systems. In such examples, balancing the microscope system and of the plurality of microscope systems over time may be demanded to ensure uniformity and usability of the collected data. Balancing fluorescence microscope systems using an organic fluorophore target such a dye molecule may lead to inconsistencies due to photobleaching. Additionally, many organic fluorophores have narrow absorption and emission bandwidths and may thus not be usable for balancing across all wavelength channels of a microscope system. In comparison, an inorganic crystalline material may absorb and emit across multiple wavelengths of visible light. Additionally, inorganic crystalline materials may be physically robust and photostable. Use of a photostable fluorescence balancing target including an inorganic crystalline fluorophore may result in uniform balancing of a microscope system and/or a plurality of microscope systems across multiple wavelength channels.

Inorganic crystalline materials, especially colored transition metal doped inorganic crystalline materials (e.g., gemstones), may be considered as a fluorophore for a photostable balancing target. Table 1 shows a non-limiting list of possible examples of inorganic crystalline materials which may be used as the fluorophore.

TABLE 1

| | Blue | Green | Red | Far Red |
|---|---|---|---|---|
| | 0.4 sec | 0.9 sec | 0.2 sec | 2.0 sec |
| Sample | exposure | exposure | exposure | exposure |
| Moonstone | 23 | 6 | 0 | 1 |
| (Na,K)AlSi₃O₈ | | | | |
| Garnet | 6 | 4 | 0 | 2 |
| Fe⁺²₃Al₂SiO₁₂ | | | | |
| Adventurine | 30 | 486 | 8 | 173 |
| SiO₂ + | | | | |
| K(Al,Cr)₂(AlSi₃O₁₀)(OH)₂ | | | | |
| Sodalite | 6 | 2 | 2 | 0 |
| Nas(Al₆Si₆O₂₄)Cl₂ | | | | |
| Emerald | 497 | 288 | 84 | 2112 |
| Be₃Al₂(SiO₃)₆ | | | | |
| Pearl | 220 | 64 | 4 | 4 |
| CaCO₃ + conchiolin | | | | |
| Carnelian 2 | 27 | 71 | 11 | 42 |
| SiO₂ + Fe₂O₃ | | | | |
| Tanzanite | 8 | 25 | 2 | 4 |
| Ca₂Al₃(SiO₄)(Si₂O₇)O(OH) | | | | |
| Sapphire | 71 | 60 | 89 | 1519 |
| Al₂O₃:Fe,Ti | | | | |
| Peridot | 1146 | 4095 | 15 | 6 |
| (Mg,Fe)₂SiO₄ | | | | |
| Carnelian 1 | 88 | 137 | 15 | 49 |
| SiO₂ + Fe₂O₃ | | | | |
| Ruby | 1171 | 438 | 728 | 2941 |
| Al₂O₃:Cr | | | | |

Contrast expressed as the brightest pixel value increase over a blank background, of different samples measured using blue, green, red, and far red wavelength channels of a system.

The contrast values shown in table 1 were collected using a fluorescence microscope system, such as system 100 of FIG. 1. Contrast was determined was determined for each channel following a given exposure time and was measured as the intensity of the brightest pixel increase within a field of view above a blank for that exposure time. In some examples, the inorganic crystalline fluorophore may be a transition metal doped inorganic crystalline material. In further examples, the inorganic crystalline fluorophore may be a colored gemstone. In addition to photophysical properties, the inorganic crystalline fluorophore may be selected based on physical properties such a hardness. For example, the inorganic crystalline fluorophore may be ruby, sapphire, or emerald based on both a measurable photoresponse across blue, green, red, and far red channels and on a high hardness which may resist cracking or fracturing.

Turning now to FIGS. 3A-3B, images acquired with a fluorescence microscope system, such as the system 100 of FIG. 1, are shown. FIG. 3A shows images 300 of crushed synthetic emerald crystals while FIG. 3B shows images 350 of crushed synthetic ruby crystals. Crushed crystals were affixed to a slide for imaging using non-fluorescent adhesive. Although not shown, natural ruby crystals were also imaged and share similar fluorescent characteristics with synthetic ruby. Images 300 and images 350 were each collected using the same fluorescence microscope system.

Images 300 includes a first emerald image 302, a second emerald image 304, a third emerald image 306, and a fourth emerald image 308. First emerald image 302 was collected using a blue channel exposed for 10 seconds. Second emerald image 304 was collected using a green channel exposed for 20 seconds. Third emerald image 306 was collected using a red channel exposed for 40 seconds. Fourth emerald image 308 was collect using a far red channel exposed for 20 seconds. By adjusting exposure times for each channel, emerald fluorescence and shapes of the crushed emerald crystal may be visible in each image.

Images 350 include a first ruby image 352, a second ruby image 354, a third ruby image 356, and a fourth ruby image 358. First ruby image 352 was collected using the blue channel exposed for 0.5 seconds. Second ruby image was collected using the green channel fluorescence exposed for 2 seconds. Third ruby image 356 was collected using the red channel exposed for 1 second and the fourth ruby image was collected using the far red channel exposed for 20 seconds.

It may be appreciated that ruby fluorescence is visible in each of images 350 while the exposure times for first ruby image 352, second ruby image 354 and third ruby image 356 are each shorter than the corresponding exposure times for images 300. For this reason, in some examples, the inorganic crystalline fluorophore may be ruby in order to observe a strong fluorescence with a short exposure time. Further, comparing fourth ruby image 358 and fourth emerald image 308, both were collected for a same exposure time and show similar fluorescence contrast. In alternate examples, where assays are primarily measured using the far red channel, the inorganic crystalline fluorophore may be emerald.

Turning now to FIG. 4, images 400 of crushed synthetic ruby are shown. The ruby imaged in FIG. 3B may be the same as the ruby shown in FIG. 4. Images 400 include a first image 402 taken before attempted photobleaching and second image 404 taken after attempted photobleaching. In the example of FIG. 4, attempted photobleaching includes exposing the ruby to light from each of the blue channel, the green channel, the red channel, and the far red channel simultaneously for 50 seconds. Comparing first image 402 to second image 404, the fluorescence intensity (e.g., contrast of images 400) does not change after illumination. In contrast, photobleaching of organic dyes is evident under the same illumination conditions. In this way, it is shown that ruby is a photostable material when illuminated for a period of time with wavelengths relevant to the microscope system.

Turning now to FIG. 5A, an image of a photostable fluorescence balancing target 500 is shown. A reference axis 501 is shown for reference between FIGS. 5A and 5B. Reference axis 501 includes a y-axis, x-axis, and a z-axis. Photostable fluorescence balancing target 500 may include a holder 502. Holder 502 may have a length 504 with respect to the y-axis, a width 506 with respect to the x-axis, and a depth 508 with respect to the z-axis. Length 504, width 506, and depth 508 may be chosen to correspond to dimensions of a conventional sample holder of a microscope system (e.g., the system 100 of FIG. 1) being balanced. As one example, if the microscope system is configured with a sample holder to hold 96-well microplates, length 504, width 506, and depth 508 may be chosen to correspond to a 96-well microplate blank. Configuring holder 502 in this way may aid in precise and reproducible positioning of photostable fluorescence balancing target 500 within an optical path of the microscope system. Additionally, the holder may be compatible with an automatic sampling system, used to automatically load and unload samples onto the sample holder of the microscope system.

Photostable fluorescence balancing target 500 may further include an inorganic crystalline fluorophore 510. Inorganic crystalline fluorophore 510 may be securely affixed (e.g., fixedly coupled to) to holder 502 by a non-fluorescent transparent adhesive such as clear polyvinyl acetate (PVA) adhesive, or the like. In some examples, inorganic crystalline fluorophore 510 may be formed as a rectangular strip of material having a length 512 with respect to the y-axis and a width 514 with respect to the x-axis. Other dimensions and shapes of inorganic crystalline fluorophore 510 such as circular or polyhedral, among others have been considered within the scope of this disclosure. In further examples, photostable fluorescence balancing target 500 may include a plurality of inorganic crystalline fluorophores 510.

Inorganic crystalline fluorophore 510 may be formed of an inorganic crystalline material capable of absorbing and emitting light across one or more wavelengths of visible light. In some examples, inorganic crystalline fluorophore 510 may be doped with a transitional metal, the energy levels of the transition metal being responsible for the absorption and emission of visible light. In some examples, the transition metal dopant may be chromium. In further examples, inorganic crystalline fluorophore 510 may be synthetic or natural mineral gemstone. Preferably, inorganic crystalline fluorophore 510 may be ruby. Further, inorganic crystalline fluorophore 510 may be unpolished ruby. In some examples, where photostable balancing target 500 includes one or more inorganic crystalline fluorophores 510, the one or more inorganic crystalline fluorophores 510 may each be formed of the same material or formed of different material. In this way, photostable fluorescence balancing target 500 may include redundancy in case of accidental degradation (e.g., scratches) of an inorganic crystalline fluorophore 510. Additionally or alternatively, photostable fluorescence balancing target 500 may include different inorganic fluorophores which may be used to balance different wavelength channels.

Looking more closely at inorganic crystalline fluorophore 510, an area 516 is shown in greater detail in FIG. 5B. Area 516 includes a fiducial marker 550. In some examples fiducial marker 550 may be shaped as a cross, however, other shapes have been considered. Fiducial marker 550 may be etched or otherwise permanently formed in or on inorganic crystalline fluorophore 510. Fiducial marker 550 may ensure each balancing method is executed with respect to an unvaried position on inorganic crystalline fluorophore 510. In this way, natural variations of inorganic crystalline fluorophore 510 which may affect fluorescence intensity, such as local chemical composition or crystalline thickness, may be mitigated. Mitigating these natural variations makes the fluorescence of inorganic crystalline fluorophore 510 more reproducible and more desirable for balancing. In some examples, inorganic crystalline fluorophore 510 may include a plurality of fiducial markers and the plurality of fiducial markers may be labeled. In this way, redundancy may be provided in an event of accidental degradation to inorganic crystalline fluorophore 510 at a position of the fiducial marker 550.

Turning now to FIG. 6, a flowchart of an example of a method 600 for balancing a fluorescence microscope system using a photostable fluorescence balancing target (e.g., the target) is shown. The fluorescence microscope system may be microscope system 100 of FIG. 1 and/or the multi-detector system 200 of FIG. 2. The target may be photostable fluorescence balancing target 500 of FIGS. 5A-5B. The method 600, may be at least partially executed by a processor of a computing system, such as the processor 126 of the computing system 124 of FIG. 1, according to instructions stored in non-transitory memory of the computing system (e.g., within the image processing module 132 of the memory 128 of FIG. 1).

At 602, method 600 includes positioning a holder (e.g., holder 502 of FIG. 5A) of the target on a sample holder (e.g., sample holder 108) of the system and centering a fiducial marker (e.g., fiducial marker 550 of FIG. 5B) of the target in a field of view of the system. In some examples, the holder of the target may be formed in a shape matching a shape of the samples typically measured by the system. In this way, the holder of the target may be easily mounted on the sample holder of the system. In some examples, the holder may be positioned automatically by the arm of an autosampler. The fiducial mark indicates a position on an inorganic crystalline fluorophore that may be used for balancing repeatedly over time and over one or more fluorescence microscope systems.

At 604, method 600 includes defining a pixel area for balancing. In a non-limiting example, the pixel area may be bounded by a square. The square may be positioned with respect to the fiducial marker each time method 600 is executed. For example, when the fiducial marker is shaped as a cross, the pixel area may be centered around the intersecting lines of the cross.

At 606, method 600 includes setting an exposure time for each wavelength channel of the system. The system may include n wavelength channels. The n wavelength channels may span a wavelength range between blue and far red. For example, the system may include a blue channel, a green channel, a red channel, and a far red channel. Setting the exposure time for each wavelength channel may include setting the exposure times according to an inorganic crystalline fluorophore of the target. For example, a memory of the system may store a look up table containing exposure times for each wavelength channel for a plurality of inorganic crystalline fluorophores. Accordingly, setting the exposure time for each wavelength channel of the system may include inputting an identity of the inorganic crystalline fluorophore and in response, the system may automatically set exposure times for each wavelength channel.

At 608, method 600 includes setting a pixel average threshold and an allowable range around the pixel average threshold. The pixel average threshold may be a desired average pixel value (e.g., contrast value) within the pixel area defined at step 604. The pixel average threshold may be set based on a value which has been previously been determined to result in usable images of an assay. The pixel average threshold may be between 0 and 40,000. In some examples the pixel average threshold may be 20,000. The allowable range may be a variation from the pixel average threshold which is deemed allowable. In some examples, the allowable range may be between 5 and 10.

At 610, method 600 includes imaging the target in an n^{th} wavelength channel with the fluorescence microscope system. An image may be acquired using the exposure time of the n^{th} wavelength channel set at step 606. In some examples, the image may be stored in transitory and/or non-transitory memory of the fluorescence microscope system. At 612, method 600 includes determining if the pixel average measured in the defined pixel area is within the allowable range of the pixel average threshold. If the measured pixel average is not within the allowable range of the pixel average threshold, method 600 proceeds to 616 and includes adjusting the excitation intensity of the n^{th} wavelength channel. The intensity may be adjusted in order to bring the measured pixel average closer to (e.g., within the allowable range of) the pixel average threshold. For example, if the measured pixel average is below the allowable range of the pixel average threshold the excitation intensity of the n^{th} wavelength channel may be increased, and if the measured pixel average is above the allowable range of the pixel average threshold the excitation intensity of the n^{th} wavelength channel may be decreased. In some examples, the excitation source may be a light emitting diode (LED) and adjusting the excitation intensity may include adjusting a power supplied to the LED.

Method 600 returns to 610 for re-imaging of the target in the n^{th} wavelength channel and then proceeds to 612 to again determine if the pixel average measured within the pixel area is within the allowable range of the pixel average threshold. In this way, the excitation energy of the n^{th} wavelength channel may be adjusted in steps until the measured pixel average is within the allowable range of the pixel average threshold. In some examples, the steps may include adjusting the excitation source by an equivalent amounts each time step 616 is executed. In alternate examples, the steps may include adjusting the excitation source by variable amounts each time step 616 is executed.

When at 612, method 600 determines that the pixel average is within the allowable range of the pixel average threshold, method 600 proceeds to 614 and includes determining if there are additional wavelength channels that have not yet been balanced. If at 614, method 600 determines there are additional wavelength channels that have not been balanced, method 600 returns to 610 and images the target at a different wavelength channel that has not yet been balanced. If at 614, method 600 determines that there are not additional wavelength channels that have not been balanced, method 600 proceeds to 618 and includes proceeding with a fluorescence assay. When the microscope system is the multi-detector system, proceeding with the fluorescence assay may include imaging using each of the n wavelength channels simultaneously.

In this way, each of the n wavelength channels of the system may be balanced to each other. In some examples, the microscope system may be a first microscope system of a plurality of microscope systems. Method 600 may be repeated for each microscope system of a plurality of fluorescence microscope systems to balance fluorescence images between the plurality of fluorescence microscope systems.

The target may be photostable and may not photobleach while method 600 is being executed and, additionally, may not photobleach while method 600 is being executed on the plurality of fluorescence microscope systems. Because the target may not photobleach, the pixel area may be positioned in substantially (e.g., +/−5%) the same place for each wavelength channel and for each microscope system of the plurality of fluorescence microscope systems. Said another way, the same pixel area and fiducial may be used for each wavelength channel and each time method 600 is executed. For this reason, method 600 may not include compensation for photobleaching of the target or for spatial inhomogeneity of the target. Because the same pixel area is used and may not demand user interaction to adjust a position of the pixel area due to photobleaching, method 600 may be automated by instructions stored in the memory of the microscope system.

Turning now to FIG. 7, and example of an image 700 of a photostable fluorescence balancing target is shown. The inorganic crystalline fluorescence balancing target may be photostable fluorescence balancing target 500 of FIGS. 5A-5B. Image 700 may correspond to an image of the target collected with an n^{th} wavelength channel at a set exposure time according to step 610 of method 600. Fiducial marker 704 may be centered in image 700 and a pixel area 702 may be designated and positioned at a reproducible point on the image with respect to the fiducial marker. As shown in image 700, the fiducial marker 704 may be a cross, and pixel area 702 may be positioned around an intersection point 706 of the cross.

Image 700 may correspond to an image ready for balancing using the target as described above with respect to method 600. Turning now to FIG. 8, a graph 800 of measured pixel area and excitation intensity is shown as excitation is increased in a stepwise fashion. Graph 800 includes a left axis 802 corresponding to excitation intensity and a right axis 804 corresponding to a pixel average measured within a pixel area, such as pixel area 702 of FIG. 7. A bottom axis 806 corresponds to sequential steps taken to balance the fluorescence microscope system. For example, each time excitation intensity is adjusted and then compared to a pixel average threshold as described in steps 612 and 616 of the method 600 may be a step. Number of steps increases from left to right along bottom axis 806. Plot 808 corresponds to a measured pixel average within the pixel area as denoted by right axis 804. Plot 810 corresponds to an excitation intensity of a wavelength channel being balanced as denoted by left axis 802. At each step excitation intensity increases resulting in an increase measured average pixels within the pixel area.

Dotted line 812 of graph 800 corresponds an average pixel threshold as denoted by right axis 804. Increasing steps stop when plot 808 intersects with dotted line 812. The wavelength channel may be considered balanced when plot 808 reaches the average pixel threshold.

A technical effect of the systems and methods provided herein is that a microscope system and/or a plurality of microscope systems may be balanced without having to account for photobleaching. For example, the same area of an inorganic crystalline fluorophore may be used repeatedly for balancing each wavelength channel of the microscope system and/or plurality of microscope systems due to the photostability of the inorganic crystalline fluorophore. In this way, data collect for fluorescence assays over time using a plurality of samples and/or a plurality of fluorescence microscope systems may be analyzed and compared in a meaningful way.

The disclosure provides support for a photostable fluorescence balancing target, comprising, a holder, an inorganic crystalline fluorophore affixed to the holder, and a fiducial marker positioned on the inorganic crystalline fluorophore. In a first example of the system, the photostable fluorescence balancing target is configured to balance each wavelength channel of a multi-detector microscopy system. In a second example of the system, optionally including the first example a width, and a depth of the holder are based on a sample holder of a microscope system. In a third example of the system, optionally including one or both of the first and second examples, the inorganic crystalline fluorophore includes a transition metal dopant. In a fourth example of the system, optionally including one or more or each of the first through third examples, the inorganic crystalline fluorophore is doped with chromium. In a fifth example of the system, optionally including one or more or each of the first through fourth examples, the inorganic crystalline fluorophore is ruby. In a sixth example of the system, optionally including one or more or each of the first through fifth examples, the inorganic crystalline fluorophore absorbs and emits multiple wavelengths of visible light. In a seventh example of the system, optionally including one or more or each of the first through sixth examples, the fiducial marker is one of a plurality of fiducial markers, and the plurality of fiducial markers are labeled.

The disclosure also provides support for a method of using a photostable fluorescence balancing target, comprising: positioning the photostable fluorescence balancing target on a sample holder of a microscope system, imaging an inorganic crystalline fluorophore of the photostable fluorescence balancing target in a wavelength channel of the microscope system and defining a pixel area, in response to a pixel average of the pixel area not being within an allowable range of a pixel average threshold, adjusting an excitation intensity of the wavelength channel and re-imaging the pixel area. In a first example of the method, the microscope system is a multi-detector system. In a second example of the method, optionally including the first example, the inorganic crystalline fluorophore includes a fiducial marker. In a third example of the method, optionally including one or both of the first and second examples, imaging the inorganic crystalline fluorophore includes imaging the fiducial marker and defining the pixel area is based on a position of the fiducial marker. In a fourth example of the method, optionally including one or more or each of the first through third examples, the method further comprises: in response to the pixel average of the pixel area being within the allowable range of the pixel average threshold, proceeding to image the photostable fluorescence balancing target in a different wavelength channel. In a fifth example of the method, optionally including one or more or each of the first through fourth examples, the method further comprises: prior to imaging the inorganic crystalline fluorophore, setting an exposure time for each wavelength channel of the microscope system based on an identity of the inorganic crystalline fluorophore.

The disclosure also provides support for a method of using a photostable fluorescence balancing target, comprising, positioning the photostable fluorescence balancing target on a sample holder of a first microscope system, imaging an inorganic crystalline fluorophore of the photostable fluorescence balancing target with a first wavelength channel of n wavelength channels of the first microscope system and defining a pixel area, balancing the first wavelength channel and each of the n wavelength channels of the first microscope system based on a pixel average in the pixel area, wherein a position of the pixel area is substantially the same when balancing the first wavelength channel and balancing each of the n wavelength channels of the first microscope system. In a first example of the method, the first microscope system is one of a plurality of microscope systems and the method further includes balancing each microscope system of the plurality of microscope systems, and wherein the position of the pixel area is substantially the same when balancing the each of the plurality of microscope systems. In a second example of the method, optionally including the first example, the method is executed automatically by the first microscope system. In a third example of the method, optionally including one or both of the first and second examples, the method further comprises: after balancing the first wavelength channel and each of the n wavelength channels, proceeding with a fluorescence assay, wherein proceeding with the fluorescence assay includes imaging with each of n wavelength channels simultaneously. In a fourth example of the method, optionally including one or more or each of the first through third examples, balancing the first wavelength channel and each of the n wavelength channels includes adjusting an intensity of an emission source of the first wavelength channel and each of the n wavelength channels. In a fifth example of the method, optionally including one or more or each of the first through fourth examples, the first wavelength channel and each of the n wavelength channels span a wavelength range between blue and far red.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A photostable fluorescence balancing target, comprising;
a holder;
an inorganic crystalline fluorophore affixed to the holder; and
a fiducial marker positioned on the inorganic crystalline fluorophore.

2. The photostable fluorescence balancing target of claim 1, wherein the photostable fluorescence balancing target is configured to balance each wavelength channel of a multi-detector microscopy system.

3. The photostable fluorescence balancing target of claim 1, wherein a length, a width, and a depth of the holder are based on a sample holder of a microscope system.

4. The photostable fluorescence balancing target of claim 1, wherein the inorganic crystalline fluorophore includes a transition metal dopant.

5. The photostable fluorescence balancing target of claim 1, wherein the inorganic crystalline fluorophore is doped with chromium.

6. The photostable fluorescence balancing target of claim 1, wherein the inorganic crystalline fluorophore is ruby.

7. The photostable fluorescence balancing target of claim 1, wherein the inorganic crystalline fluorophore absorbs and emits multiple wavelengths of visible light.

8. The photostable fluorescence balancing target of claim 1, wherein the fiducial marker is one of a plurality of fiducial markers, and the plurality of fiducial markers are labeled.

9. A method of using a photostable fluorescence balancing target, comprising:
positioning the photostable fluorescence balancing target on a sample holder of a microscope system;
imaging an inorganic crystalline fluorophore of the photostable fluorescence balancing target in a wavelength channel of the microscope system and defining a pixel area;
in response to a pixel average of the pixel area not being within an allowable range of a pixel average threshold, adjusting an excitation intensity of the wavelength channel and re-imaging the pixel area.

10. The method of claim 9, wherein the microscope system is a multi-detector system.

11. The method of claim 9, wherein the inorganic crystalline fluorophore includes a fiducial marker.

12. The method of claim 11, wherein imaging the inorganic crystalline fluorophore includes imaging the fiducial marker and defining the pixel area is based on a position of the fiducial marker.

13. The method of claim 9, further comprising in response to the pixel average of the pixel area being within the allowable range of the pixel average threshold, proceeding to image the photostable fluorescence balancing target in a different wavelength channel.

14. The method of claim 9, further comprising, prior to imaging the inorganic crystalline fluorophore, setting an exposure time for each wavelength channel of the microscope system based on an identity of the inorganic crystalline fluorophore.

15. A method of using a photostable fluorescence balancing target, comprising;
positioning the photostable fluorescence balancing target on a sample holder of a first microscope system;
imaging an inorganic crystalline fluorophore of the photostable fluorescence balancing target with a first wavelength channel of n wavelength channels of the first microscope system and defining a pixel area;
balancing the first wavelength channel and each of the n wavelength channels of the first microscope system based on a pixel average in the pixel area; wherein a position of the pixel area is substantially the same when balancing the first wavelength channel and balancing each of the n wavelength channels of the first microscope system.

16. The method of claim 15, wherein the first microscope system is one of a plurality of microscope systems and the method further includes balancing each microscope system of the plurality of microscope systems, and wherein the position of the pixel area is substantially the same when balancing the each of the plurality of microscope systems.

17. The method of claim 15, wherein the method is executed automatically by the first microscope system.

18. The method of claim 15, further comprising, after balancing the first wavelength channel and each of the n wavelength channels, proceeding with a fluorescence assay, wherein proceeding with the fluorescence assay includes imaging with each of n wavelength channels simultaneously.

19. The method of claim 15, wherein balancing the first wavelength channel and each of the n wavelength channels includes adjusting an intensity of an emission source of the first wavelength channel and each of the n wavelength channels.

20. The method of claim 15, wherein the first wavelength channel and each of the n wavelength channels span a wavelength range between blue and far red.
